(19) United States
(12) Patent Application Publication
(10) Pub. No.: US 2010/0298126 A1
(43) Pub. Date: Nov. 25, 2010

(54) HIGHLY ACIDIC CATALYST FOR USE IN FLUID CATALYTIC CRACKING

(75) Inventors: Elbert Arjan De Graaf, Amsterdam (NL); Daniel Alofs-Gimpel, Wormer (NL); King Yen Yung, Almere (NL); Raymond Paul Fletcher, Houston, TX (US); Avelino Corma Canos, Valencia (ES)

Correspondence Address: Albemarle Netherlands B.V.;Patent and Trademark Department, 451 Florida Street, Baton Rouge, LA, 70801, US

(73) Assignee: ALBEMARLE NETHERLANDS B.V., AMSTERDAM (NL)

(21) Appl. No.: 12/681,319

(22) PCT Filed: Oct. 3, 2008
(86) PCT No.: PCT/US08/78756

§ 371 Date: Aug. 13, 2010

Related U.S. Application Data
(60) Provisional application No. 60/977,189, filed on Oct. 3, 2007.

(51) Int. Cl. B01J 27/182; B01J 27/25

(52) U.S. Cl. 502/201; 502/214

(57) ABSTRACT

A particulate unsupported superacid catalyst for use in fluid catalytic cracking is provided comprising doped silica which has been doped with from about 1 to about 99 wt %, based on the weight of the catalyst composition, of at least one inorganic oxide dopant selected from the group consisting of rare earth metal oxides, alkaline earth metal oxides, zinc oxide, magnesium oxide, manganese oxide, yttrium oxide, niobium oxide, zirconium oxide and titanium oxide, and wherein the doped silica has been anion-modified by an anion selected from the group consisting of phosphate, tungstate, and sulphate.

This invention relates to a particulate unsupported highly acidic catalyst. More particularly, this invention is concerned with a superacid catalyst comprising a doped silica, a method of producing said catalyst and the use of said material in fluid catalytic cracking (FCC).

While gasoline is usually the most valuable product of fluid catalytic cracking (FCC) in oil refining, light cycle oil (LCO) is an important by-product. In winter the value of light cycle oil, when used as a blending component in heating oil, can be even greater than that of gasoline. Under such circumstances, many refineries can adjust their FCC unit operation in order to increase LCO yield at the expense of gasoline. This is normally achieved by lowering the unit's cracking severity by reducing at least one of the catalyst activity, the reactor temperature and the catalyst/feedstock (oil) ratio.

The increased recent demand for gas oil for diesel engines has lead investigators to consider increasing the amount of LCO in the gas-oil pool. However, to meet the regulatory requirements for diesel fuel, refiners have recognized that LCO must be improved for this purpose by, for example, reducing the levels of sulphur and nitrogen containing compounds, in particular alkyldibenzothiophenes and carbazoles. Furthermore, the LCO must be improved by lowering its aromatics content given that LCO typically comprises about 70 wt. % diaromatic compounds, of which alkylnaphthalenes are the most common, and about 15 wt. % 3+ ring aromatics.

Although the addition of aromatics to a fuel from LCO will both improve its cold flow properties and increase its density and heating value, the aromatics will however reduce the cetane number of that fuel. Further, aromatic compounds, and especially polynuclear-aromatics, have been identified as major contributors of vehicular NOₓ and particulate matter (PM) emissions. Unreacted aromatic compounds that are released by engines during combustion of a high aromatic fuel are also considered detrimental.

Most States of the U.S.A. thus limit the total aromatics level in diesel fuel to 35 percent by volume. The California Air Resources Board has imposed the more stringent regulatory level of 10 percent by volume as it has been shown that decreasing the total aromatic content in diesel fuel from 30 to 10 percent can reduce nitrogen dioxide emissions by about 3 to 5 percent. As these and other regulatory regimes may continue to become stricter on vehicular emissions, there is consequently a need to further reduce the level of aromatics in diesel and thus concomitantly in LCO if it is to be used within the gas-oil pool.

According to the UOP Publication “LCO Upgrading: A Novel Approach for Greater Added Value and Improved Returns”, AIChE Chicago Symposium—2006, the components of LCO boil in the diesel range with a 95% point of 360° C. or higher, and thus represent thermally stable cracked hydrocarbons that are not usually further reacted in the FCC process. This document infers that, in the absence of overcracking, the aromatics content of the LCO fraction of an FCC unit, as a function of conversion, is not significantly impacted by the FCC catalyst employed. Consequently, the aromatics content of the LCO fraction of an FCC unit is traditionally lowered by treating that fraction after it has been extracted from the unit. This treating predominantly involves hydrotreating and hydrocracking processes which seek to saturate and open the di-aromatic rings.

Japanese Patent Application Laid-Open No. JP8333586 (SHOWA SHELL SEKIYU) describes a method for lowering inter glia the aromatics content of an LCO feed by subjecting said feed to deep-desulphurization. Similarly, U.S. Pat. No. 5,219,814 (MOBIL OIL CORPORATION) describes a moderate pressure hydrocracking process in which an LCO feedstock, having an aromatic content of at least 5 percent and an API less than 25, is de-aromatized by hydrocracking over a catalyst comprising ultrastable Y-Zeolite, a Group VIII metal and a Group VI metal.

Unlike the above patents, Pine et al. in “Prediction of Cracking Catalyst Behavior By a Zeolite Unit Cell Size Model” Journal of Catalysis 85, 466-476 (1984) does consider modifying the catalyst employed in the FCC unit to affect the composition of the LCO fraction. However, this document is concerned with promoting the conversion of LCO naphthalene into single ring aromatics by using known FCC catalyst compositions but at reduced unit cell size. It is not concerned with the total aromatics content of the LCO fraction.

International Patent Publication No. WO97/18892 (Hydrocarbon Technologies Inc.) describes the cracking of a feed comprising long chain paraffins by contacting said feed with a supported superacid catalyst in either a fixed or a fluidized type catalyst bed. The catalyst comprises from 5 to 20 wt. % of a transition metal oxide, from 2 to 8 wt. % of an anion modification compound (preferably a sulphate) and from 0.05 to 5 wt. % of an active promoter metal. The bulk of the catalyst, from 70 to 90 wt. %, is comprised of a support material such as alumina or a zeolite. As the described acidic catalytic cracking mechanism proceeds to convert the long chain paraffins into aromatic compounds, in particular asphaltenes (toluene solubles), the teaching of this document does not meet the need in the art to reduce such aromatic compounds.

Accordingly, the present invention achieves the desired reduction in the aromatics content of the LCO fraction of an FCC unit by subjecting said feed to cracking in the presence of a novel, highly acidic catalyst.

In accordance with a first aspect of the invention there is provided a particulate unsupported superacid catalyst for use in fluid catalytic cracking, said catalyst comprising doped-silica which has been anion-modified by an anion selected from the group consisting of phosphate (PO₄), tungstate (WO₄), and sulphate (SO₄). In a preferred embodiment, the catalyst is characterized in that: i) the catalyst comprises from about 1 to about 99 wt. % (based on the weight of the catalyst) of an inorganic oxide dopant selected from the group consisting of rare earth metal oxides, alkaline earth metal oxides, zinc oxide, magnesium oxide, manganese oxide, yttrium oxide, niobium oxide, zirconium oxide and titanium oxide; and, ii) said particles of the catalyst have a BET surface area, measured by nitrogen adsorption, in the range from about 50 to about 500 m²/g and a mean particle size of about 20 to about 150 μm.

The meaning of doped herein is intended to indicate that the dopant material does not merely coat the surface of the silica particles. At least part of the dopant inorganic metal oxide is included in the silica such that it can only be removed therefrom by destroying the silica structure.

The acidity of purely siliceous solids is typically very low. However, the incorporation of the inorganic oxide dopants, particularly Zr(IV) and Ti(IV) oxides, into the siliceous framework produces a substantial enhancement of the acidity. Without being bound by theory, the increased acidity observed in the merely doped silica samples is due to the presence of surface metal atoms with a low coordination, mainly creating Lewis acid sites. The number of acid sites is further enhanced by the modification of the doped silicas with one of the phosphate, tungstate or sulphate oxyanions. In accordance with the theory proposed by Arata et. al, Proceedings 9^{th} International Congress, 4, 1727-1735 (1998) this increase in acidity may be due to co-ordination of the bidentate oxyanions to the dopant metals.

The acidity of the catalysts of the present invention may be sufficiently high for them to be characterized as “superacids”. The term “superacid” as employed in this patent application is that used by Tanabe et al. in “New Solid Acids and Bases: Their catalytic properties” Studies in Surface Science and Catalysis Vol. 51, the disclosure of which is incorporated herein by reference. Superacids are defined as a class of acidic materials which have an acidity greater than that of 100% H₂SO₄, which is turn is quantified by the Hammett acidity function, Ho, as −11.9. A solid having Ho <−11.9 may be referred to as solid superacid.

In accordance with a one preferred embodiment of the invention, the catalyst may be characterized by comprising from about 1 to about 20 wt. % of said inorganic oxide dopant. Preferably, that inorganic oxide dopant comprises at least one of titania and zirconia.

Additionally, it is preferred that the catalyst comprises from 0 to about 40 wt. % (based on the weight of the catalyst) of a binder, said binder preferably comprising alumina The catalyst may advantageously also comprise from 0 to about 25 wt. % (based on the weight of the catalyst) of a metal trap.

In accordance with a further embodiment of the invention, the catalyst is characterized by comprising particles having a BET surface area in the range from about 125 to about 225 m²/g and a mean particle size between about 60 and about 80 μm.

It is known that FCC catalysts can become deactivated following contact with certain heavy metal contaminants present in the hydrocarbon feedstock. These contaminant metals include vanadium, nickel, iron, copper and sodium, of which vanadium is considered the most deleterious. These metals may be present in the hydrocarbon feedstock as free metals or as components of inorganic and organic compounds such as porphyrins and asphaltenes. In addition to lost activity, the catalyst may become less selective, resulting in increased amounts of undesirable products, particularly coke and light gases such as hydrogen, methane and ethane.

A “metal trap” is a material that when introduced into the catalyst inventory selectively reacts with migrating metal, thus protecting the active components of the catalyst. The trap may be incorporated into the catalyst, or introduced as a separate particle. In accordance with one embodiment of the invention, the acidic catalyst of the present invention may comprise such a “metal-trap”. In that embodiment, the catalyst preferably comprises from 0 to about 25 wt. % of the metal trap. Suitable metal traps are disclosed inter alia in U.S. Pat. Nos. 6,159,887; 4,889,615; and, 5,057,205, the disclosures of which are incorporated herein by reference in their entireties.

In accordance with a second aspect of the invention there is provided a process for producing a particulate unsupported catalyst comprising doped silica as defined above, said process comprising:
a. Mixing a source of an inorganic metal oxide dopant with a source of silica to form a slurry of silica particles doped with the inorganic metal oxide;
b. Aging the slurry;
c. Optionally separating the doped silica material from the aged slurry; and,
d. Subjecting the aged slurry or the separated, doped silica to anion modification using one of a phosphating agent, a tungstating agent and a sulphating agent.

The step of mixing the inorganic oxide dopant and slurrying the precipitate with the silica source serves to at least partially embed the inorganic oxide into the silica particulate structure. The inorganic oxide dopant may be precipitated from an aqueous solution or a slurry or gel of the dopant from an oxide or hydroxide source may be employed. The silica source need not necessarily be initially provided in the particulate form; this step is also envisaged to include the possibility of precipitating the silica from an aqueous solution or other solvent source in the presence of the inorganic oxide precipitate and the possibility of co-precipitating the silica with the inorganic oxide.

In accordance with the preferred embodiments of this process, at least part of the inorganic metal oxide dopant may be precipitated in the presence of said silica source. Preferably that silica comprises a silica sol.

It is also preferred that the metal oxide dopant is precipitated from the aqueous solution by increasing the pH of said aqueous solution by addition of a base, preferably ammonium hydroxide, thereto. Ideally, the pH is increased to between about 7 and about 10, preferably about 8 to about 9.

In a further embodiment it is preferred that the slurry further comprises at least one of a particulate alumina, a metal trap and a stabilizer.

In accordance with a preferred embodiment of the invention the separated, doped silica (catalyst precursor) is subjected to at least one thermal treatment at a temperature between about 100 and about 400° C. prior to the anion modification step. This thermal treatment may constitute at least one of drying and calcining the catalyst precursor.

In accordance with a third aspect of the invention there is provided a fluid catalytic cracking (FCC) process comprising contacting a hydrocarbon feedstock with a catalyst as defined above under conditions comprising a temperature in the range from about 450° to about 780° C., a residence time from about 0.01 seconds to about 2 minutes, and at a catalyst-to-feedstock ratio in the range from about 1 to about 100, preferably from about 3 to about 20 and most preferably from about 4 to about 10. In a further embodiment, an FCC process comprises contacting a hydrocarbon feedstock under similar conditions with a catalyst composition comprising i) doped silica which has been doped with at least one inorganic oxide dopant selected from the group consisting of rare earth metal oxides, alkaline earth metal oxides, zinc oxide, magnesium oxide, zirconium oxide and titanium oxide, and wherein the doped silica has been anion-modified by an anion selected from the group consisting of phosphate; and ii) wherein the catalyst composition comprises a lesser amount of large pore zeolite on a weight basis as compared to the amount of doped silica. In this embodiment, the catalyst composition may comprises less than 50 wt % large pore zeolite, less than 25 wt %, less than 15 wt %, less than 10 wt %, less than 5 wt %, and may be essentially free of large pore zeolite.

In accordance with a fourth aspect of the invention there is provided a LCO fraction obtained directly from an FCC unit in which a hydrocarbon feedstock has been contacted with a catalyst as defined above. Said LCO fraction is characterized by a low aromatics content, typically having less than about 40 wt. % aromatics, depending on the feedstock. The substantially lowered aromatics content of the “raw” LCO from the FCC unit may potentially enable it to be blended into the fuel oil and heating oil pool without the need for expensive treatments (hydrotreating and hydrocracking).

The unsupported, highly acidic (superacidic) catalysts of the present invention and the use thereof in FCC units are not taught or suggested in the prior art. Additionally, the low aromatic content of the LCO fraction derived by contacting an FCC feedstock with such a highly acidic catalyst is unexpected; it has not previously been postulated that a catalytic mechanism over a high acidic catalyst could so reduce aromatic compounds.

By “zirconia” is meant an oxide of zirconium. An exemplary zirconia is zirconium oxide (ZrO₂). Similarly, by “titania” is meant an oxide of titanium. An exemplary titania is titanium (IV) oxide (TiO₂).

The terms “phosphated”, “tungstated” and “sulphated” as used herein are meant to describe the doped silica treated with anion modification compounds as described herein and not necessarily to mean that phosphate, tungstate or sulphate anions are attached to the silica.

The term “aromatics” shall mean compounds having one or more than one benzene ring.

The term “cracking” shall mean the reactions comprising breaking of carbon-carbon bonds and carbon-hydrogen bonds of at least some feed molecules and the formation of product molecules that have no carbon atom and/or fewer carbon atoms than that of the feed molecules.

The term “catalyst to feedstock ratio” shall mean the relative amount of catalyst to hydrocarbon by weight.

The doped silicas of the present invention are prepared by either co-precipitation of the silica and the inorganic oxide dopant, the precipitation of the inorganic oxide dopant in the presence of a suitably dispersed silica or the addition of at least part of the inorganic oxide to such a suitably dispersed silica. The different precipitation techniques will, of course, affect the dispersion of the dopant metal oxide within the silica and more particularly whether the dopant metal is embedded homogeneously throughout the silica (e.g. by co-precipitation) or concentrated at the surface (e.g. by staged co-precipitation or precipitation of the inorganic oxide dopant in the presence of a silica dispersion). As the metals ions of the dopant metal oxide should be accessible to co-ordination with the modifying anions, it is preferable that the precipitation method at least partially concentrates the dopant metal at or near the silica surface.

Further and alternative precipitation methods suitable for forming the doped silica slurry are disclosed in U.S. Pat. No. 7,070,749 and European Patent No. 0 643 015, the disclosures of which are herein incorporated by reference.

For a co-precipitation method, suitable sources of silica include silicic acid, ethyl orthosilicate, silicon tetrachloride and sodium silicate. Each of these silicon compounds is used in a condition where it is dissolved in water, an acid or a water-alcohol mixing solvent. Of the above-mentioned examples, sodium silicate is preferred for economy and ease of handling.

Sources of silica in a suitably dispersed form include silica hydrosol, silica gel, silica sol, and silicic acid. The preferred source of silica is an aqueous colloidal dispersion of silica particles. Silica sols suitable for use in the present invention are any of those derived from an ion-exchange process which have a substantially uniform particle size within the range of about 20 to about 400 Angstroms. A commercial source of such a sol is Ekasil, which is high pH stabilized and contains silica particles of approximately 40 nm.

Suitable sources of zirconium as the dopant metal include aqueous solutions of ZrOCl₂, ZrO(NO₃)₂, ZrO(OH)NO₃, ZrOSO₄, zirconyl acetate, zirconium propoxide and the like. Of these zirconyl nitrate is the most preferred and is available from American Elements®. The concentration of these aqueous solutions can be as high as about 2M.

Sources of titanium include titanium hydroxide, titanium sulfate, titanium oxysulfate, titanium nitrate, titanium tetrachloride and orthotitanates. Each of these titanium compounds is used in a condition where it is dissolved in water, an acid or a water-alcohol mixing solvent. Of the above-mentioned examples, aqueous titanium hydroxide and titanium nitrate are particularly preferable.

The rare earth metals suitable for preparing the catalysts in accordance with one aspect of the invention are selected from yttrium, lanthanum, cerium, praseodymium, and dysprosium, and mixtures thereof. Aqueous solutions containing these one or more rare earth metals—from which the insoluble oxide forms may be precipitated—may be prepared from bromate, halide, nitrate and sulfate salts thereof and also from organic complexes of the rare earth metals with ethylene diamine tetraacetic acid (EDTA). Presently rare earth nitrate solutions are preferred.

Zinc and magnesium ions may be furnished in any acceptable salt having a measurable solubility in water. Solutions that may be employed therefore include zinc and magnesium salts of the following anions: acetate, bromide, carbonate, citrate, chloride, (trihydrate) nitrate and sulphate. Also the use of MgO and Mg(OH)₂ in the preparation can be used by adding these materials to the silica source, followed by an optional aging step before shaping.

As described above the catalyst may further comprise up to 40 wt. % (based on the weight of the catalyst) of a binder which serves to enhance the strength of the catalyst particles. Alumina is the preferred binder of the present invention, a conventional source of which is colloidal alumina. A preferred source of the alumina binder is an alumina sol having a viscosity in the range of about 1 to about 50 Centipoise (cP), generally about 10 to about 20 cP.

Suitable metal traps and the sources thereof are disclosed inter alia in U.S. Pat. Nos. 6,159,887; 4,889,615; and, 5,057,205, the disclosures of which are herein incorporated by reference.

Central to the present invention is that the dopant metal oxides are induced to precipitate in such a way as to embed in the surface or within the structure of the silica. Although all methods of inducing precipitation are envisaged within the scope of this invention, the dopant metal oxides are preferably induced to precipitate by raising the pH of their aqueous source solutions. Any base which will either react with the aqueous dopant salts to form a precipitated oxide in the presence of dispersed silica, or react with the aqueous salts to co-precipitate silica and inorganic dopant oxide may be used. However, although inorganic bases, such as NaOH, and other bases such as amines, substituted amines, carbamides and ammonium compounds could be used, the preferred base is NH₄OH, particularly when the precipitation solution is water. NH₄OH (commonly referred to variously as ammonium hydroxide solutions, aqueous ammonia or an ammonia solution) may be obtained from a plurality of known commercial sources such as Mallinckrodt Baker Inc. (NJ, USA).

The amount of base added to the aqueous solution of the inorganic dopant metal obviously determines the pH of the resultant reaction mixture which in turn determines the rate of precipitation. More particularly, the pH of the mixture determines whether premature precipitation of the inorganic metal oxides takes place completely or in part. If premature precipitation of these oxides takes place, they will obviously not be co-precipitated with silica or will not embed in that silica in the desired fashion. Equally, the pH of the reaction mixture determines the surface area and particle size of the doped silica formed by the (co-) precipitation. For the inorganic oxides precipitated in this invention it has been found that the addition of any alkaline solution should be controlled to achieve a pH of the reaction mixture between about 7.5 and about 10, preferably between about 8 and about 9 and most preferably about 8.5.

It does not appear to be critical whether the base is added to the reaction mixture in combination with the silica source, the inorganic oxide (dopant) source or independently of both sources. Accordingly, the alkaline solution may be added to the silica source first, into which the aqueous solution comprising the dopant metal is then mixed. Alternatively, the alkaline solution may be added to the aqueous solution comprising the dopant metal to initiate precipitation before it is mixed with the silica source. As a further alternative, the silica source and the aqueous solution of the dopant metal may be mixed together, after which the pH of the mixture is raised by addition of the alkali thereto. As mentioned previously, staged mixing of the silica source, dopant metal sources and alkali can also modify the distribution of the dopant metal oxide on the surface and in the structure of the silica.

It is critical to the process of this invention that the (co-)precipitation of the silica and inorganic oxide dopant occurs under mixing conditions that are sufficiently turbulent as to create a homogeneous slurry. Also, as the slurry will become more viscous with time as the precipitation reaction(s) progress, the mixing severity must either be variable or the mixing vessel must allow for the further addition of water or a diluent. The skilled reader would be aware of a number of suitable mixers that could be used. However, methods employing impeller-type mixers are most preferred.

It is preferred that the slurry be mixed at a temperature between about ambient temperature and about 90° C. for up to about 24 hours.

Any further materials that are to be included in the catalyst particles should preferably be present under mixing conditions in this slurry. These materials, such as metal traps and binders, may be added separately or with one of the other components of the reaction mixture.

Small quantities of stabilizers may optionally be added to the slurry prior to or during the precipitation of the inorganic oxide dopant. For example, small quantities yttria, haffnia, CaO, MgO, and CeO₂ have been used to stabilize zirconia and titania oxides. Where such stabilizers are added to the slurry, it is preferable that they are included in an amount between about 1 and about 10 wt. %, preferably between about 2 and about 5 wt. % based on the weight of inorganic oxide dopant.

In accordance with the invention, the slurry may be subjected to an aging step. The slurry is preferably aged between about ambient temperature and about 90° C. for at least about one hour followed by washing with water, aqueous ammonium nitrate, and again water.

Although the anion modification step of the present invention can involve agents which can act within aqueous or other solutions—such that phosphating, sulphating and tungstating could therefore be performed in the aged slurry—it is preferred for reasons discussed herein below to first: i) separate the doped silica from the slurry; and, ii) subject the separated product to at least one thermal treatment at a temperature between about 100° C. and about 700° C., preferably between about 150° C. and 400° C. This thermal treatment may be provided by drying and/or calcining the doped silica (catalyst precursor). Most preferably, a separated catalyst precursor is subjected to both drying and calcining—and optionally shaping—prior to the anion modification.

The separation may comprise simple filtration of the slurry to form a wet filter cake. However, as a number of other ions could have been introduced into the slurry and therefore may exist within that wet filter cake, it is preferable to at least re-disperse the filter cake in ion-exchanged water and refilter it. This re-dispersion/filtration may be performed as many times as desired.

The filter cake thus formed may be dried at a temperature between about 60 and about 400° C. for between about 1 and about 12 hours, preferably at a temperature between about 100 and about 300° C., for between about 1 and about 2 hours. The filter cake may be dried in any type of drier commonly used in the art, such as a spray-dryer, nozzle-tower dryer, spin-flash dryer, Buttner dryer or rotary tube furnace. Although shaping of the doped-silica may occur in a separate step, the preferred drying process of the present invention employs a dryer, which can additionally shape the doped-silica. As such, a spray-dryer is the most preferred form.

After drying—and optionally shaping—the doped silica is preferably calcined. Calcining of the doped-silica—and more particularly calcining of un-phosphated or phosphorus-free doped-silica—is carried out at a temperature within the range from about 300° to about 800° C., preferably within the range from about 300° to about 600° C., for a time between about 1 minute and about 48 hours, preferably between about 0.5 and about 10 hours. At these temperatures, conventional calcination procedures may be employed, using atmospheres of air, steam, steam mixed with air or an inert gas. Inert gases such as nitrogen and helium are preferred, either by themselves or mixed with steam. Generally, convenience will dictate that the calcination will be completed using the same atmosphere throughout the process.

The dopant inorganic oxide may be modified with an anion by treating either the aqueous slurry of the precipitated doped-silica, the wet filtercake, the dried doped-silica or the calcined doped-silica (all of which may collectively be considered as catalyst precursors). However, it is preferred that the anion modification is applied to doped silica that has been subjected to a thermal treatment whether by drying and/or calcination. This thermal treatment is particularly preferred when the dopant is titania or zirconia; it is suggested by K. Arata et al. in Proceedings 9th International Congress on Catalysis, Volume 4, pages 1727-1735 (1988) that a thermal treatment of precipitated titania and zirconia at a temperature from 100° C. to about 400° C. results in species which can interact more favorably with the modifying anion. This thermal treatment is believed to result in the condensation of TiOH and ZrOH groups to form a polymeric titania and zirconia species with surface hydroxyl groups.

The anion modification compounds—which may variously be described as phosphating agents, sulphating agents or tungstating agents—are preferably used in an amount to react with the surface of the doped-silica to give a (A)/Si atom ratio of the reaction product on the surface between about 0.2:1 and about 2:1, preferably between about 0.6:1 and about 0.9:1 where A is the element P, S or W. In practice, however, it is possible to use as much of the agents as desired with the excess thereof simply being washed off after the modification treatment is complete.

Of the disclosed anion modifiers of the present invention, it is preferred that the doped-silica is subjected to a phosphating step. The phosphating agent can be any source of phosphorus that either comprises phosphates or phosphorous ions and phosphorus-containing ions which can be converted to said phosphates under calcination or otherwise. The preferred phosphates for use in this invention include monoammonium dihydrogen phosphate, diammonium hydrogen phosphate and metal phosphates.

Phosphorus compounds which can be vaporized, such as POCl₃ (phosphoryl chloride) or PCl₃ (phosphorus trichloride) may also be used as the phosphating agents. And further suitable phosphating agents include phosphorus acid, othophosphoric acid, polyphosphoric acid, phosphine and phosphine derivatives and organic phosphorus compounds such as phosphonium salts.

The treatment to produce the phosphated doped silica is obviously dependent on the phosphating agent employed. For phosphating agents that may be applied in aqueous or organic solution, phosphating is generally carried out by forming a slurry of the catalyst precursor and adding the agent thereto or vice versa. Such a phosphating treatment is generally carried out at a temperature between about 15° C. and about 500° C., but preferably between about ambient temperature and the boiling point of the solvent. The time over which the treatment is applied may range from about 1 minute to about 2 hours but is preferably between about 2 and about 30 minutes.

Where the phosphating agent is POCl₃ (phosphoryl chloride) or PCl₃ (phosphorus trichloride), these compounds are vaporized and the vapor contacted with the catalyst precursor. These materials will react with surface OH groups and give off HCl. This vapor treatment can be carried out at a temperature between the vaporization temperature of the compound and about 400° C., but is preferably carried out at about 200° C. Again, the time over which the treatment is applied may range from about 1 minute to about 2 hours but is preferably between about 2 and about 30 minutes.

Analogously to the above phosphating treatment, sulphate anion modification is preferably achieved by treating one of catalyst precursors with sulphuric acid, for example 0.01-10M sulphuric acid, preferably 0.1-5M sulfuric acid. However, other compounds that are capable of providing sulphate ions, such as ammonium sulphate, can be employed. Equally, an alternative method of sulphate anion modification is to treat an uncalcined catalyst precursor with compounds such as hydrogen sulfide, sulfur dioxide or mercaptans which are capable of forming sulphate ions upon calcination. The sulphating agent and the catalyst precursor should preferably be under mutual contact for a time period of from about 12 to about 48 hours.

Similarly, suitable sources for the tungsten oxyanion include, but are not limited to, ammonium metatungstate, tungsten chloride, tungsten carbonyl, tungstic acid and sodium tungstate. The tungstating agent and the catalyst precursor should preferably be under mutual contact for a time period of from about 12 to about 48 hours.

Depending on their uses, the catalytic materials of the present invention may be used as support for further catalytically active metals or metal compounds. For example, suitable catalytically active materials include metals or metal compounds of copper, iron, chromium, vanadium, gold and Group VIII noble metals. The catalytically active metals or metal compounds may be combined with the catalytic materials of the present invention in any conventional way known in the art such as deposition, impregnation and at any suitable stage of the preparation of the doped silica, including before or after calcination of the doped silica.

The catalysts of this invention may be employed in any type of fluidized catalyst bed. Accordingly they may be employed in inter alia dense fluidized beds, moving or ebullating beds and circulating dilute-phase fluidized beds.

The feedstock to an FCC unit is typically vacuum gas oil (VGO) but can include many other heavy streams, such as straight run gas oil, coker gas oil, hydrocracked gas oil, atmospheric bottoms, vacuum bottoms and DAO/DMO. As the skilled refiner would be aware, the crude source and amount of resid in the feed determine the levels of feed contaminants such as carbon residues (Conradson carbon, Ramsbottom carbon or MCRT) and metals (primarily nickel and vanadium).

The temperature and pressure of the FCC process may vary depending on the precise nature of the reactants, the catalyst, and the desired product, but will generally fall within certain ranges. Typically the process involves contacting the hydrocarbon feedstock with the catalyst composition at conditions comprising a temperature from about 450 to about 780° C., a reactor residence time from about 0.01 seconds to about 2 minutes, and optionally added steam. The quantity of catalyst employed will depend on many variables such as the precise catalyst used, temperature, pressure, reactants, reactant feed rate, and yield vs. cost considerations. However, it is envisaged that the catalyst-to-feedstock (oil) ratio will be in the range from about 1 to about 100, preferably from about 3 to about 20 and most preferably about 4 to about 10.

### EXAMPLES

The invention is illustrated in the following non-limiting examples, which are provided for the purpose of representation, and are not to be construed as limiting the scope of the invention.

In the Examples the physicochemical properties of the catalysts were characterized using the following techniques.

While determination of the acid strength of liquid superacids is relatively straightforward, the exact acid strength of a solid strong acid is difficult to directly measure with any precision because of the less defined nature of the surface state of solids relative to the fully solvated molecules found in liquids. Two methods of determining superacidity were performed in this application:

A presumption of superacidity is made when the solid candidate compound has the ability to isomerize n- to isobutane at temperatures below 200° C. This presumption was made in the IUPAC Publication Sommer et al. “Carbenium and carbonium ions in liquid- and solid-superacid-catalyzed activation of small alkanes”, Pure Appl. Chem., Vol. 72, No. 12, pp. 2309-2318, 2000; and

The materials were determined as superacids by the color change of the Hammett indicator. As the acid strength of 100% sulfuric acid expressed by the Hammett acidity function, Ho, is −11.9, a solid having Ho <−11.9 may be referred to as solid superacid. The use of Hammett indicators to measure the acidity of solid sup eracids is discussed in the Soled et al. U.S. Pat. No. 5,157,199 the disclosure of which is herein incorporated by reference.

B.E.T. surface areas of the catalyst in accordance with this invention were measured for samples out-gassed in situ using nitrogen adsorption technique (at 77K) over a P/Po range of 0.02-0.2 using a multi-point Coulter SA 3100 instrument. The adsorption isotherm was measured and the BET equation used to give specific surface area from this data. By B.E.T. is intended herein a nitrogen adsorption method of Braunauer, Emmett and Teller as shown in “Adsorption of Gases in Multi-Molecular Layers,” J. Am. Chem. Soc., Vol. 60 (1938), pp. 309-319.

The skilled reader would be aware of a number means by which the particle size distributions of the materials in calcined, phosphated or phosphated and calcined states may be obtained. These include particle size analysis by use dynamic light scattering, electrozone sensing, laser diffraction (LALLS), microscopy, sedimentation and sieving.

Doped silica catalysts were prepared containing 50 wt % SiO₂ and 50 wt % of a dopant oxide, including cerium oxide, MgO, zirconia, and titania. The silica (Ekasil®) was mixed with a heel of metal nitrate (dopant) solution in a beaker and a magnet stirrer. The pH of the dopant was adjusted to about 8.5 by adding 10 wt % NH₄OH prior to addition of the silica source. All samples were prepared at room temperature and aged for 1 hour. Subsequently, the catalysts were dried in an oven at 120° C. over night. Catalysts comprising more than one dopant were similarly prepared, including 50 wt % SiO₂ and 25 wt % of both lanthanum oxide/zirconia, cerium oxide/zirconia, or lanthanum oxide/cerium oxide. The catalysts exhibited BET surface areas in the range of from 100 to 300 m²/g and a mean particle size of from 20 to 150 μm. After calcining the catalysts at 600° C., MAT (Micro Activity Testing) results at a reaction temperature of 500° C. and cat-to-oil ratio of from 5 to 10 illustrated that the prepared catalysts exhibit low LCO aromaticity at acceptable coke make, LCO yield, and conversion.

Additional catalysts were prepared by adding titania hydroxide or zirconia nitrate to a heel of water. Ammonia was added until the pH was adjusted to 8.5. Thereafter, silica was added. The metal hydroxide and silica slurry gels rapidly. Water may be added to lower the viscosity. The resulting slurry was spray dried and calcined. Phosphate doping is added via contacting the catalyst with water and H₃PO₄ (per 13.77 gram catalyst, 9.801 g 85% H₃PO₄ and 79.5 ml water). Subsequently, the sample was dried overnight at 120° C. and calcined for 2 hours at 625° C. Bottoms conversion for both phosphate doped TiO₂ and ZrO₂ doped SiO₂ was comparable. Cracking over the ZrO₂ doped samples tended to be more acidic and yield a lower coke formation. Phosphate doped catalysts exhibit improved LCO selectivity and high activity.

1. A superacid particulate catalyst composition comprising doped silica which has been doped with at least one inorganic oxide dopant selected from the group consisting of rare earth metal oxides, alkaline earth metal oxides, zinc oxide, magnesium oxide, manganese oxide, yttrium oxide, niobium oxide, zirconium oxide and titanium oxide, and wherein the doped silica has been anion-modified by an anion selected from the group consisting of phosphate, tungstate, and sulphate.

2. The composition of claim 1 wherein said inorganic oxide dopant comprises at least one of titania and zirconia.

3. The composition of claim 1 wherein the doped silica comprises between about 1 to 99 wt % of the at least one inorganic oxide dopant.

4. The composition of claim 1 wherein the catalyst composition has a BET surface area in the range of about 50 to about 500 m²/g and a mean particle diameter in the range from about 20 to about 150 μm.

5. The composition of claim 1 further comprising a binder.

6. The composition of claim 5, wherein the binder comprises alumina.

7. The composition of claim 1 further comprising a metal trap.

8. A process for producing a superacid particulate catalyst composition comprising doped silica which has been doped with at least one inorganic oxide dopant selected from the group consisting of rare earth metal oxides, alkaline earth metal oxides, zinc oxide, magnesium oxide, manganese oxide, yttrium oxide, niobium oxide, zirconium oxide and titanium oxide, and wherein the doped silica has been anion-modified by an anion selected from the group consisting of phosphate, tungstate, and sulphate, the process comprising the steps of:
a. Mixing a source of the at least one inorganic metal oxide dopant with a source of silica to form a slurry of silica particles doped with the at least one metal oxide dopant;
b. Optionally aging the slurry;
c. Optionally separating the doped silica from the aged slurry;
d. Subjecting the doped silica to anion modification using one of a phosphating agent, a tungstating agent and a sulphating agent.

9. The process of claim 8, wherein at least part of the at least one inorganic metal oxide is precipitated in the presence of the silica source.

10. The process according to claim 8, wherein the source of silica comprises a silica sol.

11. The process according to claim 8, wherein the metal oxide dopant is precipitated from the aqueous solution by increasing the pH of said aqueous solution by addition of a base.

12. The process according to claim 11, wherein the base is ammonium hydroxide.

13. The process according to claim 11, wherein the pH is increased to between about 8 and about 9.

14. The process according to claim 8, wherein the slurry further comprises at least one of a particulate alumina, a metal trap and a stabilizer.

15. The process according to claim 8 further comprising the step of separating the doped silica from the slurry prior to anion modification.

16. The process according to claim 15, wherein the separated doped silica is subjected to at least one of the following steps prior to said anion modification step:
a) drying;
b) shaping, and
c) calcining.

17. A fluid catalytic cracking (FCC) process comprising contacting a hydrocarbon feedstock with a catalyst comprising doped silica which has been doped with at least one inorganic oxide dopant selected from the group consisting of rare earth metal oxides, alkaline earth metal oxides, zinc oxide, magnesium oxide, manganese oxide, yttrium oxide, niobium oxide, zirconium oxide and titanium oxide, and wherein the doped silica has been anion-modified by an anion selected from the group consisting of phosphate, tungstate, and sulphate under FCC process conditions comprising a temperature in the range from about 450° to about 780° C., a residence time from about 0.01 seconds to about 2 minutes, and at a catalyst-to-feedstock ratio in the range from about 1 to about 100.

18. The process of claim 17 wherein the catalyst comprises a lesser amount of large pore zeolite on a weight basis as compared to the amount of doped silica.

19. The process of claim 18 wherein the catalyst is essentially free of large pore zeolite.
